(19) United States
(12) Patent Application Publication
(10) Pub. No.: US 2023/0253573 A1
(43) Pub. Date: Aug. 10, 2023

(54) METHOD FOR PRODUCING CATALYST FOR OXYGEN REDUCTION REACTION OF ELECTROCHEMICAL CELL

(71) Applicants: HYUNDAI MOTOR COMPANY, SEOUL (KR); KIA CORPORATION, SEOUL (KR); INHA UNIVERSITY RESEARCH AND BUSINESS FOUNDATION, Incheon (KR)

(72) Inventors: Jong Jin YOON, Suwon-si (KR); Jong Kil OH, Yongin-si (KR); Jin Young SON, Incheon (KR); Sungjin PARK, Seoul (KR)

(21) Appl. No.: 18/073,285

(22) Filed: Dec. 1, 2022

(30) Foreign Application Priority Data
Feb. 9, 2022 (KR) 10-2022-0016588

(51) Int. Cl. H01M 4/90

(52) U.S. Cl. CPC H01M 4/9041; H01M 4/9083

(57) ABSTRACT

A method is provided for producing a catalyst for oxygen reduction reaction in an electrochemical cell. The method for producing a catalyst for an oxygen reduction reaction of an electrochemical cell comprises preparing a solution containing sodium alginate and a solvent, preparing a gel by adding a transition metal precursor to the solution, preparing a reactant by adding a nitrogen doping agent to the gel, and stirring the reactant to cause a reaction to obtain a product; and heat-treating the product.

### CROSS REFERENCE TO RELATED APPLICATION

The present application claims priority to Korean Patent Application No. 10-2022-0016588, filed Feb. 9, 2022, the entire contents of which is incorporated herein for all purposes by this reference.

### BACKGROUND

The present disclosure relates to a method for producing a catalyst for an oxygen reduction reaction in an electrochemical cell.

Oxygen reduction reaction (ORR) is a reaction that occurs at a cathode of a fuel cell and has high activation energy, so a catalyst with good activity is necessarily required to increase the efficiency of the fuel cell.

Pt/C is commercially used as a conventional catalyst for oxygen reduction reactions, but due to the high price of platinum (Pt), the need for an alternative agent thereof is increasing.

A transition metal-nitrogen-carbon compound in which cobalt (Co), iron (Fe), or nickel (Ni), which is a transition metal, and a carbon material having an sp² structure chemically doped with nitrogen are coordinate covalent bonded is known as a catalyst of high efficiency due to excellent electrical properties of the carbon material and high dispersibility of the active metal.

In particular, iron (Fe)-based transition metal-nitrogen-carbon compounds show high activity. However, if it is used in a fuel cell, iron (Fe) ions may cause contamination to the ionomer, which may cause a problem when driving the fuel cell.

### SUMMARY

An objective of the present disclosure is to provide a method for producing a catalyst for an oxygen reduction reaction of an electrochemical cell that shows excellent activity for an oxygen reduction reaction and has excellent durability and stability. The present disclosure is not limited to the objective mentioned above. Objectives of the present disclosure will become more apparent from the following description and will be realized by means and combinations thereof described in the claims.

A method for producing a catalyst for oxygen reduction reaction of an electrochemical cell, according to an embodiment of the present disclosure, includes preparing a solution containing sodium alginate and a solvent, preparing a gel by adding a transition metal precursor to the solution, preparing a reactant by adding a nitrogen doping agent to the gel, stirring the reactant to cause a reaction to obtain a product, and heat-treating the product.

The solvent may include an aqueous solvent and an organic solvent, including at least one selected from the group consisting of ethanol, ethylene glycol, and a combination thereof.

The transition metal precursor may include hexammine cobalt (III) chloride (Co(NH₃)₆]C₁₃).

The molar ratio of the transition metal precursor and sodium alginate may be about 1: ⅓ to 6.

The nitrogen dopant may include thiourea.

The reaction of the reactant may be caused by stirring the reactant at about 50° C. to 70° C. for about 12 hours to 36 hours.

The product may be heat-treated at about 700° C. to 900° C. for about 10 minutes to 2 hours in an inert gas atmosphere.

The producing method may further include washing the heat-treated product with an acid solution.

The producing method may be washing the heat-treated product with an acid solution of about 0.1 M to 1 M.

The acid solution may include at least one selected from the group consisting of sulfuric acid, hydrochloric acid, and a combination thereof.

The producing method may further include calcining the washed product.

The product may include calcining the washed product at about 700° C. to 900° C. for about 10 minutes to 4 hours in an inert gas atmosphere.

According to the present disclosure, a catalyst for an oxygen reduction reaction of an electrochemical cell that shows excellent activity against an oxygen reduction reaction and has excellent durability and stability may be obtained.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 shows a result of analyzing a catalyst, according to the present disclosure, with a transmission electron microscope (TEM);

FIG. 2 shows a result of X-ray diffraction (XRD) analysis of the catalyst according to the present disclosure;

FIG. 3 shows a result of analyzing the catalyst, according to the present disclosure, with an energy dispersive X-ray spectroscope (EDS);

FIG. 4 shows a result of measuring the BET specific surface area of the catalyst according to the present disclosure;

FIG. 5 shows a result of measuring the pore size of the catalyst according to the present disclosure;

FIG. 6 shows a result of the electrochemical performance of each catalyst measured in Experimental Example 1; and

FIG. 7 shows a result of the electrochemical performance of each catalyst measured in Experimental Example 3.

### DETAILED DESCRIPTION

The above objectives, other objectives, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

In this specification, the terms “include” or “have” should be understood to designate that one or more of the described features, numbers, steps, operations, components, or a combination thereof exist, and the possibility of addition of one or more other features or numbers, operations, components, or combinations thereof should not be excluded in advance. Also, when a part of a layer, film, region, plate, or the like, is said to be “on” another part, this includes not only the case where it is “directly on” another part but also the case where there is another part in between. Conversely, when a part of a layer, film, region, plate, and the like is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Since they are approximations reflecting various uncertainties in the measurement, they should be understood as being modified by the term “about” in all cases. In addition, when a numerical range is disclosed in this disclosure, this range is continuous and includes all values from the minimum value to the maximum value of this range, unless otherwise indicated. Furthermore, when such a range refers to an integer, all integers, including the minimum value to the maximum value containing the maximum value, are included unless otherwise indicated.

A method for producing a catalyst for an oxygen reduction reaction of an electrochemical cell, according to an embodiment of the present disclosure, may include preparing a solution containing sodium alginate and a solvent, preparing a gel by adding a transition metal precursor to the solution, preparing a reactant by adding a nitrogen doping agent to the gel, stirring the reactant to cause a reaction to obtain a product, and heat-treating the product.

The producing method may further include washing the heat-treated product with an acid solution and calcining the washed product.

The catalyst prepared by the above method may include a support formed by carbonization of sodium alginate, nitrogen (N) and/or sulfur (S) introduced into the support, and an active metal supported on the support and derived from the transition metal precursor. The catalyst may include a compound having a bonding structure of carbon (C)-nitrogen (N) or sulfur (S)-transition metal (M).

Sodium alginate is a hydrophilic polymer represented by (C₆H₇O₆Na)ₙ, and in conventional industries, it is mainly used as a food additive to increase the adhesiveness and viscosity of food, improve emulsion stability, and improve the physical properties and feel of food. The present disclosure is characterized in that the sodium alginate is carbonized to make a catalyst support. The support graphitized by heat-treating the sodium alginate at a certain temperature or higher is porous and has a plate-like structure similar to graphene and has a very wide surface area. In addition, since the support has an sp² carbon structure, electron may be conducted easily.

A solution may be prepared by dissolving the sodium alginate in a solvent. The solvent has the property of dissolving the sodium alginate and may include a mixed solvent of an aqueous solvent and an organic solvent. The aqueous solvent may include water, and the organic solvent may include at least one selected from the group consisting of ethanol, ethylene glycol, and a combination thereof. The mixing ratio of the aqueous solvent and the organic solvent is not particularly limited, and for example, may be mixed in a ratio of about 1:0.1 to 10.

A gel can be prepared by adding a transition metal precursor to the solution. The transition metal precursor may include hexammine cobalt(III) chloride ([Co(NH₃)₆]C₁₃).

When a transition metal precursor is added to the solution, hydrophilic functional groups such as a carboxyl group (—COOH) and a hydroxyl group (—OH) of sodium alginate react with the transition metal cation to form an oxygen-metal bond, and accordingly, gelation takes place.

The conditions for the gelation are not particularly limited, and for example, after the transition metal precursor is added to the solution, the mixture may be stirred at about 25° C. to 70° C. for about 1 hour to 5 hours.

The molar ratio of the transition metal precursor and sodium alginate may be about 1: ⅓ to 6. When the transition metal precursor is added according to the above molar ratio, the solution may be sufficiently gelled, and a catalyst having high activity may be prepared.

Thereafter, a reactant may be prepared by adding a nitrogen doping agent to the gel.

The nitrogen doping agent may introduce nitrogen (N) into the support and may include thiourea. When thiourea is used, sulfur (S) together with nitrogen (N) may be further introduced to the support, and thus a catalyst having higher activity may be prepared than when other nitrogen doping agents such as urea are used.

The reaction may be stirred to cause a reaction to obtain a product. Specifically, the reaction may be caused under conditions of about 50° C. to 70° C. and about 12 hours to 36 hours.

The resultant of the reaction performed under the above conditions can be centrifuged to collect the precipitated product and dried.

Thereafter, the product may be heat-treated to obtain a catalyst including the above-described support, nitrogen, and sulfur-doped on the support, and an active metal supported on the support. Specifically, the product may be heat-treated at about 700° C. to 900° C. for about 10 minutes to 2 hours in an inert gas atmosphere. The inert gas atmosphere may include a gas atmosphere such as nitrogen (N₂) or argon (Ar).

When the conditions of the heat treatment fall within the above numerical range, sodium alginate may be carbonized and converted into a support without affecting other components such as active metals.

The producing method may further include removing impurities by washing the heat-treated product with an acid solution. The concentration of the acid solution may be about 0.1 M to 1 M, and the acid solution may include at least one selected from the group consisting of sulfuric acid, hydrochloric acid, and a combination thereof.

The producing method may further include calcining the washed product. Specifically, the washed product may be calcined in an inert gas atmosphere at about 700° C. to 900° C. for about 10 minutes to 4 hours. The inert gas atmosphere may include a gas atmosphere such as nitrogen (N₂) or argon (Ar).

Hereinafter, another form of the present disclosure will be described in further detail through the following examples. The following examples are merely illustrative to help the understanding of the present disclosure, and the scope of the present disclosure is not limited thereto.

### Example

Sodium alginate was added to a mixed solvent of distilled water and ethanol, and the solution was prepared by stirring at about 60° C. for a predetermined time.

Hexammine cobalt(III) chloride ([Co(NH₃)₆]C₁₃) was added to the solution to prepare a gel. Specifically, hexammine cobalt (III) chloride was added so that the molar ratio of hexammine cobalt (III) chloride and sodium alginate was 1:6, and stirred at about 60° C. for about 3 hours to prepare a gel.

Thiourea was added to the gel, stirred at about 60° C. for about 24 hours to cause a reaction, and the resultant product was centrifuged to collect a precipitate and then dried to obtain a product.

The product was heat-treated in a nitrogen atmosphere at about 800° C. for about 1 hour.

The resultant was washed with 0.5 M sulfuric acid at about 80° C. for about 8 hours and then calcined in a nitrogen atmosphere at about 800° C. for about 3 hours to produce a catalyst.

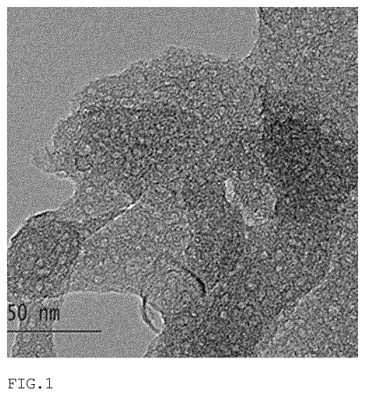

FIG. 1 shows a result of analyzing a catalyst according to the present disclosure with a transmission electron microscope (TEM). Referring to FIG. 1, it can be seen that a porous, non-agglomerated support is formed.

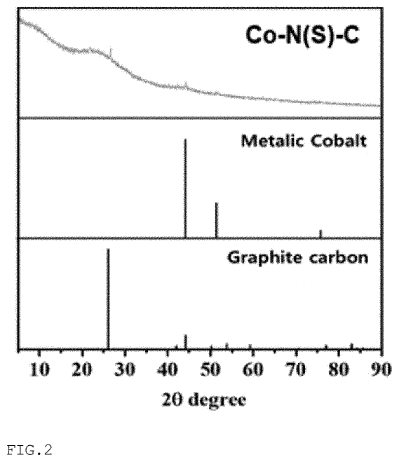

FIG. 2 shows a result of an X-ray diffraction (XRD) analysis of the catalyst according to the present disclosure. The catalysts of Examples are represented by Co—N(S)—C, and XRD results of cobalt (Co) and graphite are shown together for comparison. Referring to FIG. 2, it can be seen that the catalyst includes a support on which sodium alginate is carbonized, and cobalt (Co) is supported thereon.

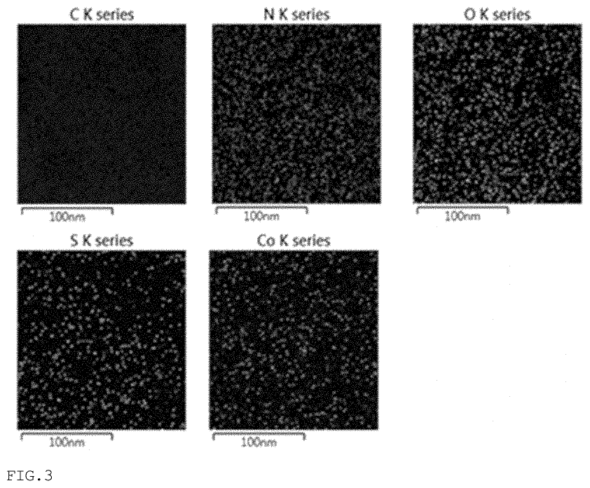

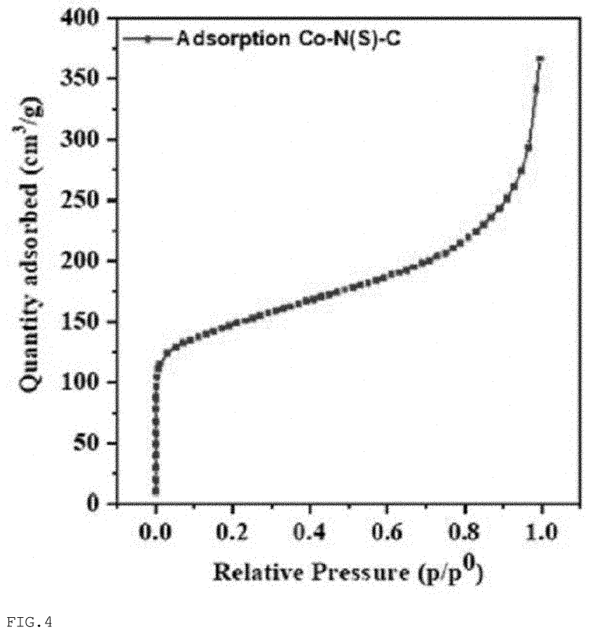

FIG. 3 shows a result of analyzing the catalyst, according to the present disclosure, with an energy dispersive X-ray spectroscope (EDS). Referring to FIG. 3, it can be seen that nitrogen (N), sulfur (S), and cobalt (Co) are evenly distributed in the catalyst. That is, it can be confirmed that the catalyst has a bond of cobalt (Co)-nitrogen (N) or sulfur (S)-carbon (C). FIG. 4 shows a result of measuring the BET-specific surface area of the catalyst according to the present disclosure. The BET-specific surface area of the catalyst calculated through this was about 527.25 m²/g.

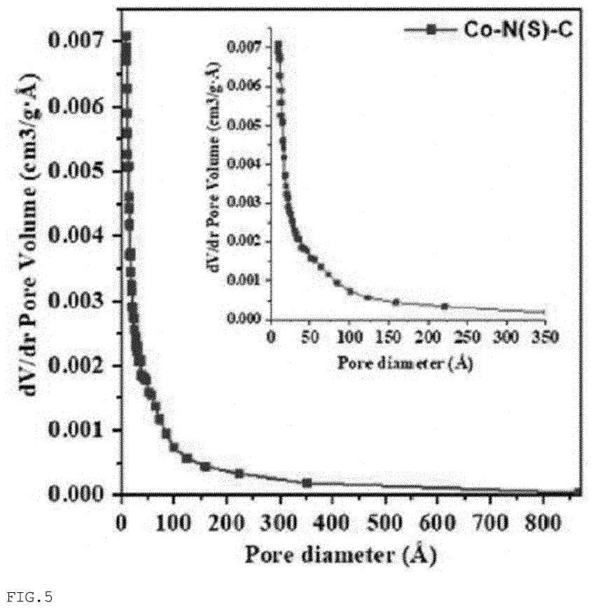

FIG. 5 shows a result of measuring the pore size of the catalyst according to the present disclosure. The average pore diameter of the catalyst calculated through this measurement was about 2.681 nm.

From the results of FIGS. 4 and 5, it can be seen that a large specific surface area of the catalyst and pores having an average diameter of about 2 nm are observed.

Table 1 below shows the results of measuring the content of each element in the catalyst, according to the present disclosure, by X-ray photoelectron spectroscopy (XPS).

TABLE 1

| Category | Unit | Content |
|---|---|---|
| Cobalt (Co) | Element %(at %) | 0.29 |
| Carbon (C) | Element %(at %) | 85.44 |
| Nitrogen (N) | Element %(at %) | 4.05 |
| Oxygen (O) | Element %(at %) | 9.76 |
| Sulfur (S) | Element %(at %) | 0.46 |

### Experimental Example 1—Electrochemical Performance Evaluation According to the Type of Nitrogen Doping Agent

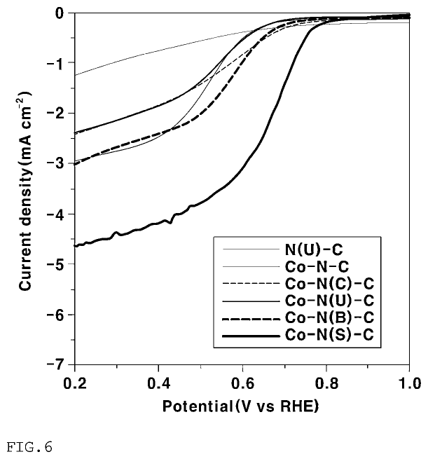

Unlike the examples, catalysts were prepared by varying the nitrogen doping agent as follows, and then the electrochemical performance of each catalyst was evaluated using a rotating disk electrode (RDE). The results are shown in FIG. 6 and Table 2.

N(U)—C: Urea is used as a nitrogen dopant, and hexammine cobalt (III) chloride ([Co(NH₃)₆]C₁₃) is not used.

Co—N—C: No nitrogen doping agent

Co—N(C)—C: Cyanamide (CN HE) is used as a nitrogen doping agent

Co—N(U)—C: Urea is used as a nitrogen doping agent

Co—N(C)—C: Boric anhydride (B₂O₃) is used as a nitrogen doping agent

Co—N(U)—C: Example

TABLE 2

| | | Half wave | |
|---|---|---|---|
| | Onset potential | potential | Current density |
| Category | [V] | [V] | [mA/cm²] |
| N(U)—C | 0.68 | 0.52 | 1.23 |
| Co—N—C | 0.68 | 0.51 | 2.95 |
| Co—N(C)—C | 0.74 | 0.54 | 2.41 |
| Co—N(U)—C | 0.70 | 0.53 | 2.38 |
| Co—N(C)—C | 0.73 | 0.55 | 2.98 |
| Co—N(U)—C | 0.80 | 0.66 | 4.60 |

Referring to FIG. 5 and Table 2, it can be seen that the performance of the catalyst according to the present disclosure is the best.

### Experimental Example 2—Evaluation of Effects According to Producing Conditions

The effect of each condition was evaluated by varying the examples and the type of solvent, the molar ratio of the transition metal precursor and sodium alginate, the type of the acid solution, and whether or not the calcining was performed. The producing conditions are summarized in Table 3 below.

TABLE 3

| | | Molar ratio of | | |
|---|---|---|---|---|
| | | transition metal | | |
| | | precursor to | Acid | Calcining |
| Category | Solvent type | sodium alginate | solution | or not |
| 1 | Distilled | 1:6 | 0.5M | ◯ |
| | water + | | sulfuric | |
| | ethylene glycol | | acid | |
| 2 | Distilled | 1:1 | 0.5M | ◯ |
| | water + ethanol | | sulfuric | |
| | | | acid | |
| 3 | Distilled | 1:1 | 1M | ◯ |
| | water + ethanol | | hydrochloric | |
| | | | acid | |
| 4 | Distilled | 1:1/3 | 0.5M | ◯ |
| | water + ethanol | | sulfuric | |
| | | | acid | |
| 5 | Distilled | 1:6 | 0.5M | X |
| | water + ethanol | | sulfuric | |
| | | | acid | |
| 6(Example) | Distilled | 1:6 | 0.5M | ◯ |
| | water + ethanol | | sulfuric | |
| | | | acid | |

The electrochemical performance of each catalyst was measured in the same manner as in Experimental Example 1 above. The results are shown in Table 4 below.

TABLE 4

| | | | | H₂O₂ | |
|---|---|---|---|---|---|
| | Onset | Half wave | Current | Yield @ | |
| | potential | potential | density | 0.7 V | |
| Category | [V] | [V] | [mA/cm²] | [%] | n @ 0.3 V |
| 1 | 0.72 | 0.54 | 3.1 | 35.2 | 3.3 |
| 2 | 0.74 | 0.57 | 4.9 | 33.7 | 3.7 |
| 3 | 0.76 | 0.62 | 3.9 | 34.6 | 3.6 |
| 4 | 0.71 | 0.53 | 3.0 | 40.6 | 3.5 |
| 5 | 0.72 | 0.55 | 4.2 | 40.4 | 3.4 |
| 6(Example) | 0.80 | 0.66 | 4.6 | 34.7 | 3.6 |

Referring to Table 4, it can be seen that the Example catalyst shows the best electrochemical performance, but each catalyst prepared in Experimental Example 2 also shows the same or similar performance as the Example catalyst.

### Experimental Example 3—Influence of Carbon Support

Urea was used instead of sodium alginate and carbonized to prepare a support. Specifically, after dissolving urea in ethanol, hexammine cobalt (III) chloride ([Co(NH₃)₆]C₁₃) is added thereto, and the resultant is heat-treated at about 620° C. in a nitrogen atmosphere for about 4 hours to prepare a catalyst. The catalyst support is carbon nitride (C₃N₄). This was named Co-UCN.

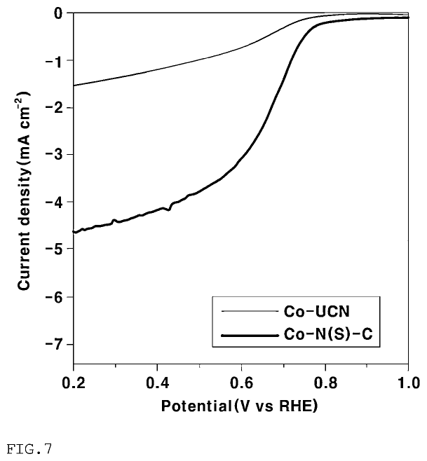

The electrochemical performance of the Example catalyst and Co-UCN was measured in the same manner as in Experimental Example 1 above. The results are shown in FIG. 7 and Table 5.

TABLE 5

| | | Half wave | |
|---|---|---|---|
| | Onset potential | potential | Current density |
| Category | [V] | [V] | [mA/cm²] |
| CO—UCN | 0.8 | 0.58 | 1.54 |
| Co—N(U)—C | 0.8 | 0.66 | 4.60 |

Referring to Table 5, it can be seen that the catalyst, according to the present disclosure, exhibits much superior activity compared to the catalyst including carbon nitride as a support.

As described above in detail, the scope of the present disclosure is not limited to the experimental examples and embodiments, and various modifications and improvements of those skilled in the art defined in the following claims are also included in the scope of the present disclosure.

What is claimed is:

1. A method for producing a catalyst for an oxygen reduction reaction of an electrochemical cell, the method comprising:
preparing a solution containing sodium alginate and a solvent;
preparing a gel by adding a transition metal precursor to the solution;
preparing a reactant by adding a nitrogen doping agent to the gel;
stirring the reactant to obtain a product; and
heat-treating the product.

2. The method of claim 1, wherein the solvent comprises:
a water-based solvent; and
an organic solvent comprising at least one of ethanol, ethylene glycol or any combination thereof.

3. The method of claim 1, wherein the transition metal precursor comprises hexammine cobalt(III) chloride ([Co(NH₃)₆]C₁₃).

4. The method of claim 1, wherein the molar ratio of the transition metal precursor and sodium alginate ranges from about 1:⅓ to 6.

5. The method of claim 1, wherein the nitrogen doping agent comprises thiourea.

6. The method of claim 1, wherein the reactant is stirred at about 50° C. to 70° C. for about 12 hours to 36 hours.

7. The method of claim 1, wherein the product is heat-treated at about 700° C. to 900° C. for about 10 minutes to 2 hours in an inert gas atmosphere.

8. The method of claim 1, wherein the method further comprises washing the heat-treated product with an acid solution.

9. The method of claim 8, wherein the heat-treated product is washed with an acid solution of about 0.1 M to 1 M.

10. The method of claim 8, wherein the acid solution comprises at least one of sulfuric acid, hydrochloric acid or any combination thereof.

11. The method of claim 8, wherein the method further comprises calcining the washed product.

12. The method of claim 11, wherein the washed product is calcined at about 700° C. to 900° C. for about 10 minutes to 4 hours in an inert gas atmosphere.
